(19) United States
(12) Patent Application Publication
(10) Pub. No.: US 2017/0102317 A1
(43) Pub. Date: Apr. 13, 2017

(54) DEVICE FOR MONITORING A LIGHT SOURCE OF AN OPTICAL SENSOR

(71) Applicant: Endress+Hauser Conducta GmbH+Co. KG, Gerlingen (DE)

(72) Inventors: Benjamin Bertsch, Gerlingen (DE); Thilo Krätschmer, Gerlingen (DE); Ralf Bernhard, Stuttgart (DE)

(21) Appl. No.: 15/287,319

(22) Filed: Oct. 6, 2016

(30) Foreign Application Priority Data
Oct. 9, 2015 (DE) 10 2015 117 265.8

(51) Int. Cl. G01N 21/17

(52) U.S. Cl. CPC G01N 21/17; G01N 2021/1751

(57) ABSTRACT

The present disclosure relates to a device for monitoring a light source of an optical sensor designed for determining a measured value of a measured parameter in a medium, including at least one light source for transmitting light along an optical path through a measuring chamber fillable with the medium, wherein the light source is associated with a receiver for receiving reception light, and at least one monitoring unit associated with the light source, with a sensory unit for monitoring the light source, wherein the monitoring unit receives transmission light, and wherein the sensory unit points in the direction of the optical path and receives light from the direction opposite the optical path. The present disclosure also relates to the use of such a device in an analyzer.

### CROSS-REFERENCE TO RELATED APPLICATION

The present application is related to and claims the priority benefit of German Patent Application No. 10 2015 117 265.8, filed on Oct. 9, 2015, the entire contents of which are incorporated herein by reference.

### TECHNICAL FIELD

The present disclosure generally relates to optical sensors, in particular, monitoring a light source of an optical sensor.

### BACKGROUND

In a variety of optical sensors, light from a light source comes into contact with a medium, e.g., a gas or a liquid, whereby the properties of the light are changed by means of interaction between the light and the medium. For instance, in photometers, the light is attenuated by absorption in the medium. In luminescence sensors, the medium is brought into an excited state by the incident light and subsequently emits optical radiation, possibly even at a wavelength that is different from that of the incident light, during the transition to the basic state. In scattered light sensors, the light is scattered in the medium by undissolved particles.

All these effects are can be used to measure a certain target parameter of the medium. In absorption or luminescence measurements, this target parameter is, for example, the concentration of a substance in the medium, and in scattered light measurements, this is, for example, the turbidity of the medium. The target parameter is determined by monitoring the properties of the light after the interaction with the medium and by correlating the thus measured, changed properties of the light with the target parameter.

In optical sensors, however, an unknown change in the incident light, e.g., a change in the intensity or the spectral distribution, thus results in an undesired measured value change. Since, in most cases, a change in the incident light cannot be completely prevented, e.g., as a result of aging of the light source, temperature changes, etc., monitoring the light source is required for the measurement accuracy of the optical sensor.

As a rule, this monitoring takes place by means of an additional light detection. The properties of the emitted light are thereby monitored before the light comes into contact with the medium. In this way, a change in the incident light can be detected and compensated for in the measured value calculation.

There are typically two different implementations for this light source monitoring. Either the light from the source is measured at a certain angle “on the side,” preferably at 90°; see FIG. 1A in this regard. Alternatively, the light is emitted “forward” toward the measuring medium and split by means of a beam splitter, wherein the diverted beam is monitored; see FIG. 1B. FIGS. 1A and 1B shows a light source 31, which radiates light into the medium 33 to be measured via an optical path 34 into a measuring chamber 35 through a window 37. Through another window 21, an optical receiver 32 detects the light changed by the medium 33. In FIG. 1A, a light monitoring unit 36 is arranged at 90° relative to the light source 1. In FIG. 1B, a beam splitter 38 is additionally arranged.

In both variants of light source monitoring (“toward the side” and “forward with beam splitter”) illustrated here, various problems can occur during implementation. A lot of space is needed along the optical path 4, i.e., along the path from light source 1 to optical receiver 2. If the optical components of the light source 1 are mounted on a circuit board, either an additional circuit board or a flex circuit board must be used for the light source monitoring. Both cases are cost-intensive. A possible change in the behavior of the additional component, the beam splitter 22, e.g., due to the time or the temperature, must also be taken into consideration.

Accordingly, there remains a need for further contributions in this area of technology for light source monitoring.

### SUMMARY

The present disclosure is, therefore, based upon the aim of providing cost-saving and space-saving light source monitoring with optical sensors. The present disclosure relates to a device for monitoring a light source of an optical sensor, which is arranged in a medium for determining a measured value of a measured parameter in process automation technology. The present disclosure also relates to a use of the device in an analyzer. The present disclosure is not to be limited to the application in process automation technology, but also encompasses at least adjoining technical fields, such as laboratory technology.

The aim of the present disclosure is achieved by a device including at least one light source for transmitting transmission light, wherein the light source is associated with a receiver for receiving reception light, wherein an optical path extends from the light source through a measuring chamber fillable with medium to the receiver, wherein the transmission light, by means of interaction in particular, absorption, scattering, and fluorescence can, depending upon the measured parameter, be converted along the optical path into the reception light, wherein a receiver signal can be generated from the converted reception light, and wherein the measured value can be determined from the receiver signal, and at least one monitoring unit associated with the light source, with a sensory unit for monitoring the light source, wherein the monitoring unit receives transmission light. The device is characterized in that the sensory unit of the monitoring unit points in the direction of the optical path and receives light from the direction opposite the optical path.

In the definition of the optical path mentioned above, i.e., from the light source to the receiver, the monitoring unit is thus, in at least one embodiment, behind the light source. This results in a cost-effective and space-saving construction.

In an embodiment, the light source and the monitoring unit are SMD components. In an embodiment, the light source and the monitoring unit are arranged on different sides of a common circuit board. The electrical and optical connection can thereby be easily realized.

In a further embodiment, the circuit board includes an opening, wherein transmission light from the light source reaches the monitoring unit through said opening. It is thus ensured that light that cannot shine through the circuit board reaches the monitoring unit.

In an alternative embodiment, the device includes an aperture along the optical path after the light source, wherein the light reflected by a surface surrounding the aperture is used to monitor the light source. The light transmitted toward the receiver is thus used to monitor the light source. To increase the signal intensity at the monitoring unit, the surface surrounding the aperture has a highly reflective or diffusely scattering surface.

In another embodiment, the monitoring unit is arranged offset from the optical path. The sensory element, the light source, and the receiver thus do not form a(n) (imaginary) straight line; instead, an angle of more than 0° is formed between the optical path and the light path from the monitoring unit to the light source. Such an angle between the optical path and the light path from the light source to the monitoring unit is more than 90°, and up to 180°.

The aim is further achieved by the use of at least one device, as described above, in an analyzer for determining a measured value of a measured parameter in process automation technology in particular, for analyzing at least one substance concentration.

An analyzer in the sense of this present disclosure shall mean a measuring apparatus in process automation technology that measures, by means of a wet-chemical method, certain substance contents such as, for example, the ion concentration in a medium that is to be analyzed. For this purpose, a sample is taken from the medium to be analyzed. The taking of the sample is performed by the analyzer itself in a fully automated fashion by means of, for example, pumps, hoses, valves, etc. For determining the substance content of a certain species, reagents that were developed specifically for the respective substance content and that are available in the housing of the analyzer are mixed with the sample that is to be measured. A color reaction of the mixture caused thereby is subsequently measured by an appropriate measuring device, such as, for example, a photometer. Specifically, the sample and reagents are mixed in a cuvette and then optically measured with different wavelengths, using the transmitted light method. Thus, the measured value is determined by the receiver, based upon light absorption and a stored calibration model. Example target measured values are, for example, ammonium, total phosphate, chemical oxygen demand, and others.

At the same time, the device according to the present disclosure may also be used in other optical units, such as a turbidity sensor or a photometer.

### BRIEF DESCRIPTION OF THE DRAWINGS

The present disclosure is explained in more detail with reference to the following figures. These show:

FIGS. 1A and 1B show exemplary light source monitoring arrangements;

FIG. 2A shows an exemplary embodiment of a device for monitoring a light source according to the present disclosure;

FIG. 2B shows an alternative exemplary embodiment of a device for monitoring a light source according to the present disclosure;

FIG. 3 shows a further exemplary embodiment of a device for monitoring a light source according to the present disclosure; and

FIG. 4 shows an analyzer employing a device for monitoring a light source according to the present disclosure.

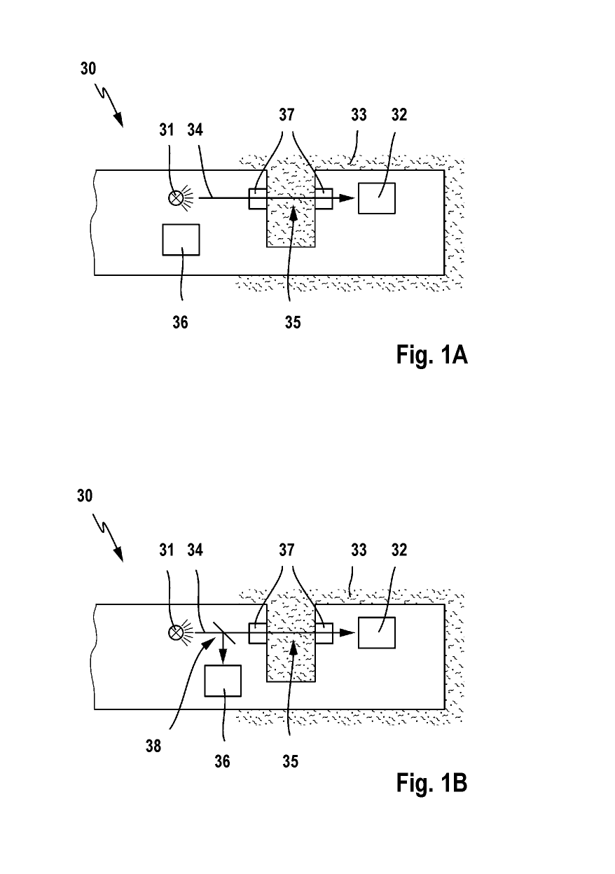

In the figures, the same features are marked with the same reference symbols.

### DETAILED DESCRIPTION

According to the present disclosure, a device 20 for monitoring a light source 1 of an optical sensor 3 for determining a measured value of a measured parameter in process automation technology of a medium 15 is presented.

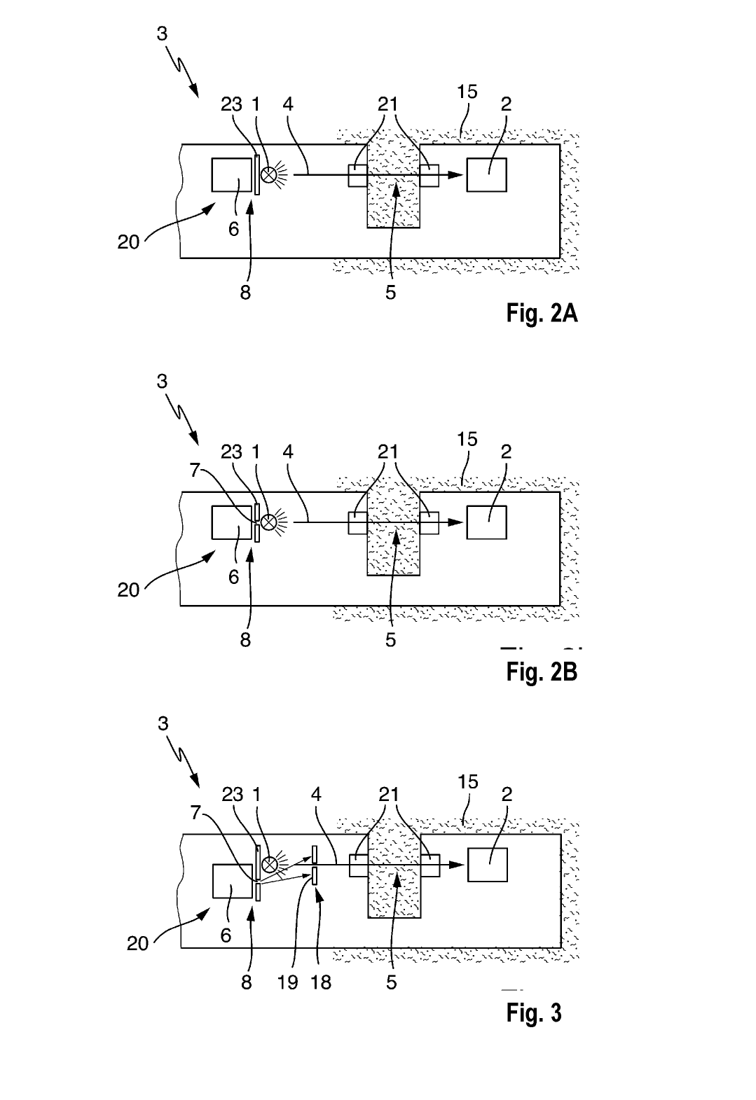

The light source monitoring according to the present disclosure is based upon a monitoring unit 6 being arranged behind the light source 1, i.e., opposite the direction of the measuring stream of light, i.e., opposite the optical path 4. The optical path 4 is defined here as the direction from the light source 1 to a light receiver 2. The light source 1 emits a measuring light along the optical path 4 toward the light receiver 2 in a transmission direction. Two facts are exploited: the light source 1 also emits some light in other directions, such as to the rear; and a lot less light is needed for the light source monitoring compared to the measurement signal detection, because, on the one hand, there is no light attenuation by interactions with the medium 15 in the light source monitoring, and, on the other hand, the optical losses as a result of the direct path are less than with the measurement signal. This is depicted in FIG. 2A. In this case, the light source 1 may be designed as a light-emitting diode (LED), such as an infrared diode or a blue-light-emitting diode. The light receiver 2 may be designed as a photodiode. The monitoring unit 6 may also be designed as a photodiode. The sensory element 8 of the monitoring unit 6 is oriented such that it is oriented in the direction of the light source 1. In other words, the sensory element 8 of the monitoring unit 6 points in the direction of the optical path 4 in the transmission direction, but receives light from the direction opposite the optical path 4 and the transmission direction.

In at least one embodiment, both the light source 1 and the monitoring unit 6 are mounted on the same circuit board 23, as is possible with, for example, an SMD (surface-mounted device) LED and an SMD photodetector. In this case, the light for monitoring goes directly through the circuit board 23, e.g., in an infrared diode, and is subsequently converted by the monitoring unit 6 into an electrical signal.

In certain cases, transmission through the circuit board 23 is not possible due to the absorption of the circuit board 23 (e.g., the remaining light intensity is too low, for example when using a blue light source 1 and a green circuit board 23). In certain embodiments as shown in FIG. 2B, an opening 7, such as a through-hole or a slot, can also be added between the light source 1 and the monitoring unit 6, through which opening 7 the light directly impinges on the monitoring unit 6.

In alternative embodiments as shown in FIG. 3, the monitoring unit 6, which is attached on the rear side of the circuit board 23, and the opening 7 through the circuit board 23 may be slightly offset from the light source 1. For measuring in such an embodiment, the measuring light goes through an aperture 18 in a surface 19, which is disposed along the optical path 4 in front of the light source 1. The surface 19 is constituted such that it reflects blocked-out light incident around the aperture 18 in the direction opposite the optical path 4. In this way, the reflected light is available for the monitoring unit 6 from the light emitted by the light source 1 in the direction of the measuring chamber 5. The surface 19 can, for example, be designed to be reflective, so as to receive as much signal as possible, or even diffusely scattering, so as to average inhomogeneities of the emitted light beam.

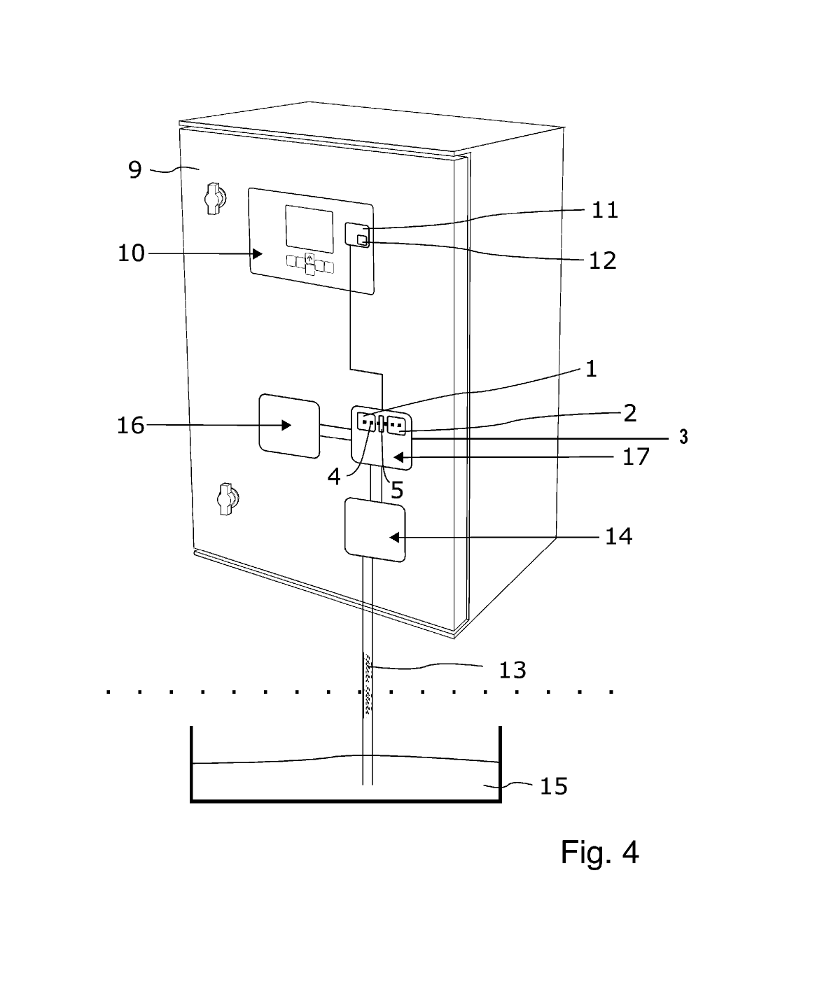

The device 20 for monitoring of the light source 1 may be employed in, for example, a turbidity sensor or a photometric sensor application. FIG. 4 shows another possible application, for example, in an analyzer 9, which is to be described in more detail.

The analyzer 9 may be structured for measuring the direct absorption of a substance or the intensity of a color, for example, which is generated by converting the substance to be determined into a color complex by means of reagents. Other possible measured parameters are, as mentioned, turbidity, or even fluorescence and others.

A further application example is the measurement of the chemical oxygen demand, or COD, with COD being a sum parameter, which means that the measured value results from the sum total of the substances and thus cannot be attributed to one individual substance. In this measurement method, a change of color is generated in a reactor; see below. Other possible parameters are, for example, total carbon, total nitrogen, or an ion concentration, such as the concentration of the ions of ammonium, phosphate, nitrate, etc.

A sample 13 is taken from the medium 15 that is to be analyzed, which medium can, for example, be a liquid or a gas. The taking of the sample 13 may be fully automatically by means of subsystems 14, such as pumps, hoses, valves, etc. For determining the substance content of a certain species, one or more reagents 16 that were developed specifically for the respective substance content and that are available in a housing of the analyzer 9 are mixed with the sample 13 that is to be measured. In FIG. 4, this is shown symbolically. In reality, the analyzer housing is provided with different vessels with different reagents, which are extracted by means of the aforementioned pumps, hoses, valves, etc., and mixed, if applicable. Likewise, for every process (i.e., taking the sample, mixing reagents, etc.), separate pumps, hoses, and valves can be used.

A color reaction caused thereby in this mixture is subsequently measured by means of a suitable sensor 3, e.g., by means of a photometer 17 arranged in the analyzer housing—shown only symbolically in FIG. 4. For this purpose, the sample 13 and the reagents 16, for example, are mixed in a measuring chamber 5 and optically measured with light of at least one wavelength using the transmitted light method described herein. In the case of determining the COD or phosphate ions, one wavelength is used. There are, however, also methods in which at least two different wavelengths are used. In these methods, light is transmitted through the sample 13 by means of the light source 1. The receiver 2 for receiving the transmitted light is aligned to the light source 1, with an optical measuring path 4 (in FIG. 4, indicated by a dotted line) extending from the light source 1 to the receiver 2. The light goes through optical windows 21 (not shown in detail in FIG. 4) through the measuring chamber 5. The light source 1 includes, for example, one or more LEDs, i.e., one LED per wavelength or an appropriate light source with broadband stimulation. Alternatively, a broadband light source fitted with an appropriate filter is used. Typical wavelengths range from infrared to ultraviolet, i.e., from approximately 1100 nm to 200 nm.

The measured value is produced by the receiver, based upon light absorption and a stored calibration function. When measuring the COD, the measured value is produced as mentioned by means of a change in color. At the beginning, the sample 13 is mixed with reagents 16, and a baseline measurement is performed. Subsequently, additional reagents 16, for example sulfuric acid, are added, and the mixture is heated to accelerate the reaction. After a certain period of time, a plateau measurement is performed. From the plateau measurement and the baseline measurement, a rise is determined, which, together with the stored calibration curve, results in the measured value.

Furthermore, the analyzer 9 includes a superordinate unit, e.g., a transmitter 10 with a microcontroller 11, along with a memory 12. The analyzer 9 can be connected to a field bus via the transmitter 10. Furthermore, the analyzer 9 is controlled via the transmitter 10. Thus, the extraction of a sample 13 from the medium 15, for example, is initiated by the microcontroller 11 by sending appropriate control commands to the subsystems 14. Likewise, the measurement by the sensor 3, viz., the photometer 17, is controlled and regulated by the microcontroller 11. The dosing of the sample 13 can also be controlled by the transmitter 10. The dosing is more or less fully automatic.

Claimed is:

1. A device for monitoring a light source of an optical sensor comprising:
at least one light source structured to emit transmission light in a transmission direction along an optical path, the at least one light source associated with a receiver structured to receive reception light, wherein the optical path extends from the light source through a measuring chamber Tillable with medium to the receiver; and
at least one monitoring unit adjacent the light source, each monitoring unit including a sensory unit configured to monitor the light source by receiving transmission light, wherein the sensory unit is oriented in the transmission direction and receives transmission light from a direction opposite the transmission direction.

2. The device of claim 1, wherein the light source and the monitoring unit are surface-mounted devices.

3. The device of claim 1, wherein the light source and the monitoring unit are arranged on different sides of a common circuit board.

4. The device of claim 3, wherein the circuit board includes an opening, wherein transmission light from the light source reaches the monitoring unit through the opening.

5. The device of claim 1, the device further comprising a surface with an aperture disposed along the optical path after the light source, wherein light reflected by the surface is received by the sensory unit.

6. The device of claim 5, wherein the surface comprises a reflective or diffusive surface. The device of claim 1, wherein the monitoring unit is offset from the optical path.

8. The device of claim 7, wherein an angle between the optical path and a light path from the light source to the monitoring unit is greater than 90°.

9. The device of claim 8, wherein an angle between the optical path and a light path from the light source to the monitoring unit is up to 180°.

10. The device of claim 1, wherein the transmission light, by means of interaction with the medium along the optical path, is converted into the reception light, such that the receiver generates a receiver signal upon receiving the reception light, wherein a measured value of a measured parameter of the medium can be determined from the receiver signal.

11. The device of claim 10, wherein the interaction is absorption, scattering, and/or fluorescence depending upon the measured parameter to be determined.

12. An apparatus comprising:
an analyzer structured to determine a measured value of a measured parameter in a medium; and
a monitoring device comprising:
at least one light source structured to emit transmission light in a transmission direction along an optical path, the at least one light source associated with a receiver structured to receive reception light, wherein the optical path extends from the light source through a measuring chamber fillable with medium to the receiver; and
at least one monitoring unit adjacent the light source, each monitoring unit including a sensory unit configured to monitor the light source by receiving transmission light, wherein the sensory unit is oriented in the transmission direction and receives transmission light from a direction opposite the transmission direction.

13. The apparatus of claim 12, wherein the analyzer is configured to determine at least one substance concentration.

14. The apparatus of claim 12, wherein the light source and the monitoring unit are surface-mounted devices arranged on different sides of a common circuit board.

15. The apparatus of claim 14, wherein the circuit board includes an opening, wherein transmission light from the light source reaches the monitoring unit through the opening.

16. The apparatus of claim 12, the monitoring device further comprising a reflective or a diffusive surface with an aperture disposed along the optical path after the light source, wherein light reflected by the surface is received by the sensory unit.

17. The apparatus of claim 16, wherein the monitoring unit is offset from the optical path, wherein an angle between the optical path and a light path from the light source to the monitoring unit is greater than 90°.

18. The apparatus of claim 12, wherein the measured value of the measured parameter of the medium is determined from the receiver signal generated by the receiver upon receiving reception light, wherein the transmission light, by means of interaction with the medium along the optical path, is converted into the reception light, and wherein the interaction is absorption, scattering, and/or fluorescence depending upon the measured parameter to be determined.
